(19) United States
(12) Patent Application Publication
(10) Pub. No.: US 2026/0061960 A1
(43) Pub. Date: Mar. 5, 2026

(54) VEHICLE OCCUPANT PROTECTION SYSTEM HAVING AN AIR BAG

(71) Applicant: ZF AUTOMOTIVE GERMANY GMBH, Alfdorf (DE)

(72) Inventors: Nico MAIER, Alfdorf (DE); Benjamin WEIMER, Spraitbach (DE); Erik HANLE, Überlingen (DE)

(21) Appl. No.: 19/104,727

(22) PCT Filed: Aug. 15, 2023
(86) PCT No.: PCT/EP2023/072438

§ 371 Date: Feb. 19, 2025

(30) Foreign Application Priority Data
Aug. 19, 2022 (DE) 10 2022 121 001.4
May 31, 2023 (DE) 10 2023 114 229.1

(51) Int. Cl. B60R 21/233; B60R 21/00; B60R 21/231; B60R 21/2338

(52) U.S. Cl. CPC B60R 21/233; B60R 2021/0053; B60R 2021/23169; B60R 2021/23382; B60R 2021/23386

(57) ABSTRACT

A vehicle occupant protection system comprises an airbag (112) for the protection of the legs of a vehicle occupant, wherein, prior to activation of the vehicle occupant protection system, the airbag (112) is arranged folded on a floor (30) of a vehicle in front of an associated vehicle seat and, in a situation of restraint, deploys from the bottom (30) in front of the vehicle seat. The airbag (112) comprises several tubular inflatable chambers (18) being in fluid connection which, when inflated, are connected three-dimensionally to one another, wherein several of the chambers (18) form support struts (124) of the airbag (112), while at least one of the chambers (18) forms a restraint chamber (22) in an upper area of the airbag (112) which is arranged directly in front of a shin area, a knee area or a pelvis area of the vehicle occupant. At least the portions of the airbag (112) which include the inflatable chambers (18) are one-piece woven.

### TECHNICAL FIELD

The invention relates to a vehicle occupant protection system comprising an airbag.

### BACKGROUND

In previous vehicle interior concepts, the vehicle occupants only have very limited legroom. While affecting the vehicle occupants'comfort, in situations of restraint this offers the advantage that the legs of the vehicle occupants are basically restrained by components affixed to the vehicle such as the bulkhead, the instrument panel or vehicle seats arranged in front of them. For improving the leg protection, moreover specific knee airbags are known which deploy from the respective structure affixed to the vehicle toward the legs of the vehicle occupant.

In new concepts, particularly in connection with autonomous driving, the vehicle occupants are intended to choose their sitting position inside the vehicle interior more freely. Accordingly, there can also be constellations in which ample legroom is available.

### SUMMARY

It is the object of the invention to improve, even in those sitting positions, the protection of the vehicle occupant's legs and the kinematics of the vehicle occupant, specifically of the vehicle occupant's legs.

This is achieved by a vehicle occupant protection system comprising an airbag for the protection of the vehicle occupant's legs which is arranged, prior to activation of the vehicle occupant protection system, folded on a floor of a vehicle in front of an associated vehicle seat and which, in a situation of restraint, deploys from the floor in front of the vehicle seat. The airbag comprises several tubular inflatable chambers in fluid connection which, when inflated, are connected three-dimensionally to one another, wherein several of the chambers form support struts of the airbag, while at least one of the chambers forms a restraint chamber in the upper area of the airbag. When the airbag is completely inflated, the restraint chamber is arranged directly in front of a shin area, a knee area or a pelvis area of the vehicle occupant. At least the portions of the airbag which include the inflatable chambers are one-piece woven.

In a situation of restraint, the airbag inter alia offers protection against the legs of the vehicle occupant in the vehicle seat swinging upwards, when the associated vehicle seat offers ample legroom to the front.

It is also conceivable to position the airbag in the area of a structure affixed to the vehicle. In this case, in a situation of restraint it acts as a knee airbag and protects the vehicle occupant's legs from contacting the structure affixed to the vehicle.

The support struts ensure that the airbag assumes its desired three-dimensional shape and stabilize the airbag in said shape. In this way, an airbag can be realized which in total encloses a very large volume but requires only a relatively small amount of filling gas due to the design of inflatable tubular chambers. Therefore, the airbag requires no further support surfaces on components affixed to the vehicle in addition to the floor of the vehicle. The airbag can be designed without great effort by varying the arrangement of the support struts in such a way that the restraint chamber for the respective vehicle and the respective restraint situation under consideration assumes the desired position.

The internal pressure of the support struts can be selected to be higher than in a conventional airbag to improve the form-stabilizing effect. Thanks to the small total volume, for this purpose no more or only insignificantly more filling gas is required than in conventional knee airbags. The airbag in itself is sufficiently resilient to cushion in particular the vehicle occupant's legs, as the tubular chambers, when loaded, yield generally by a certain degree perpendicularly to their longitudinal extension.

The support struts are preferably connected to form a three-dimensional frame. The restraint chamber forms specifically an upper cross strut of the frame, e.g. the cross strut arranged at the top relative to the vertical direction (in the completely inflated airbag).

The areas between the individual tubular chambers are preferably open so that the airbag only consists of the tubular inflatable chambers.

The airbag can have only one single or several specific restraint chambers, e.g. having a larger diameter transversely to their longitudinal extension and, thus, usually also having a larger volume than the support struts in order to obtain more extensive cushioning or better support of the legs of the vehicle occupant. In this case, each of the diameters is considered transversely to the longitudinal extension of the tubular chambers.

As a matter of course, each part of the airbag and each of the tubular chambers, viz. also the support struts, develop a restraining effect when the vehicle occupant contacts them.

The shape of the airbag can be easily adapted to the respective desired task by selecting the length and the orientation of the support struts. It is not intended to position the restraint chamber above a pelvis area of the vehicle occupant (relating to the size of a 50% dummy or a 95% dummy) in an airbag according to the invention for protecting the vehicle occupant's legs.

One of the floor-level support struts may be designed, if necessary, to cushion the vehicle occupant's heels in the area of the vehicle floor and thus to stop the forward movement of the vehicle occupant.

The support struts are configured and arranged, for example, so that when the airbag is inflated, there is room for the vehicle occupant's legs in the area beneath the restraint chamber so that centrally beneath the restraint chamber the airbag has a free space in which the legs can swing upwards and can be cushioned by the lower side of the restraint chamber, which can particularly prevent the legs from swinging upwards.

When completely inflated, the airbag can take the shape of a wedge-shaped frame that has a floor-level approximately horizontal support strut and an approximately vertical support strut on each side of the airbag. The floor-level support strut and the vertical support strut are connected to each other in an inflatable corner area. The restraint chamber extends between the upper ends of the vertical support struts.

Further, cross struts extending along the floor can connect the floor-level support struts.

In addition, there can be provided further support struts which additionally stabilize the shape. Generally, the airbag is intended to constitute a frame dimensionally stable in itself.

In order to anchor the airbag on the floor, at least at the lower ends of the vertical support struts and/or the diagonal support struts, for example, appropriate holding fixtures are arranged, such as fabric tabs woven in one piece with the remaining airbag. Said holding fixtures are connected to holding structures affixed to the vehicle on the floor of the vehicle, for example by hooking or screwing.

Preferably, all tubular chambers, viz. both the support struts and the restraint chamber, are in fluid connection with one another.

According to the invention, an airbag of this type is manufactured in portions or completely in a one-piece weaving method (One Piece Woven, OPW). This permits simple manufacture of the airbag despite its complex geometry while reducing the cutting waste.

In this weaving method, all layers of the airbag are woven simultaneously, wherein in the inflatable chambers two separate woven outer layers spaced apart from each other when inflated are formed which form a cover of the airbag in these areas and seal off the airbag from the environment. At the edges of the respective inflatable chamber, all warp and weft yarns of the two outer layers converge and are combined in one single fabric layer.

Between the two outer layers, additionally one or more further central layers can be formed by the weaving process. Those central layers consist of warp and/or weft yarns of the two outer layers, alternatively or additionally also of pile yarns, i.e. of additional yarns which are floated in the fabric of one or both outer layers. The yarns of the central layers exit one of the two outer layers usually at an attachment point and extend through the interior of the inflatable chamber to the opposite outer layer.

Basically, those central layers may have a woven structure or may consist simply of several yarns which extend in parallel but are not interconnected inside the layer.

Since yarns repeatedly leave or again enter into the fabric bond of the individual layers, the number of the yarns in the individual layers is variable on the surface area thereof.

In general, curvatures, gathers and/or bulges of the outer layers of the airbag can be produced in this way.

The airbag preferably has at least three superimposed layers at least in portions of the inflatable chambers, with a central layer being located between the two outer layers which seal off the airbag from the environment. The central layer extends between its attachment points at the two outer layers freely through the interior of the respective inflatable chamber.

The central layer is woven in one piece with the remaining layers of the airbag in the area of each of the inflatable chambers directly when the side airbag is manufactured. In particular, the central layer has a woven structure.

In a corner area of the airbag, the central layer preferably extends at least at one attachment point from one of the outer layers to the opposite outer layer through the interior of the airbag so that two support struts between which the corner area is located are adjacent to each other, when inflated, at an angle other than 0° (and other than 180°). The two inflatable chambers are specifically a floor-level support strut and a vertical support strut on one side of the airbag.

The angle is in the range of 90°, for example, so that the corner area extends in a strongly curved manner.

The central layer acts as an internal tether that predefines the position of the outer layers relative to each other when the airbag is inflated.

Preferably, there are provided several central layers which follow each other along the corner area in a longitudinal direction from the one to the other inflatable chamber.

The central layer(s) predefine(s) the position of the outer layers relative to each other when the airbag is inflated. In this way, also a curvature of the corner area is forced into the desired angle.

For example, an inner side of the curvature of the corner area is gathered and thus shortened by the central layer(s), which automatically results in a curvature of the corner area.

On each of the inner side of the curvature and an opposite outer side of the curvature of the airbag in the corner area, plural attachment points for central layers may be provided, wherein the attachment points on the outer side of the curvature are spaced apart from each other further than on the inner side of the curvature. This arrangement results in a gather of the inner side of the curvature and, consequently, in a curvature of the corner area.

In a preferred variant, the central layer is flat in the corner area and extends between the attachment points on the inner side and the outer side of the curvature rotated about an angle other than 0°, specifically rotated about 90°. When several central layers are provided in the corner area, only one, several or all of these central layers may extend rotated, wherein the angles may be selected differently for the different central layers. This design, too, results in a curved shape of the corner area and a gather of the inner side of the curvature.

The attachment points preferably are elongated. In a central layer rotated about 90°, the attachment points in the inflated airbag extend on the inner side of the curvature transversely to the vertical direction, for example, and on the outer side of the curvature along the vertical direction.

Additional seams, specifically curved seams and darts, in the corner area usually can be dispensed with by one or more of the above-described measures.

The vehicle occupant protection system preferably comprises at least one inflator which supplies filling gas to the airbag and is fastened to the floor of the vehicle.

For example, the inflator can be in fluid connection with one of the floor-level support struts of the airbag, such as by an inlet at an end remote from the vehicle seat of said support strut. In order to achieve preferably rapid inflation of the airbag, two inflators may be provided. They are positioned, for example, in the area of the two longitudinal ends of the floor-level support struts.

The fluid connection can be such that the inflator is connected directly to the support strut or via a possibly flexible gas feed line which leads to the airbag and is in fluid connection with the support strut. The latter case allows the option to mount the inflator(s) remote from the airbag.

Alternatively, or additionally, to the above-described application, a central layer can constitute a protective layer for the outer layers in a connection area of an inflator. In this way, the time required to arrange such a protective layer in the gas works can be reduced. The central layer forms a kind of pocket around the outflow openings of the inflator which guides the filling gas flowing out of the inflator into the airbag and prevents the gas from flowing directly toward the two outer layers. Such a pocket can also be formed of two or more central layers, for example.

Outside the corner area, in the inflatable chambers the central layer can extend along the longitudinal extension of the chambers through the respective chamber, which contributes to stabilizing particularly the support struts. It is also possible, however, to position central layers only in the corner areas of the airbag.

In general, all layers, viz. both the outer layers and the central layer(s) are woven to one another in one piece. Specifically, the edge areas of the airbag in which the outer layers converge contain all yarns of the two outer layers and the central layer(s).

For additional stabilization, the airbag can be tensioned via at least one tether that extends diagonally from a longitudinal end of the restraint chamber to the floor of the vehicle. Preferably, such a tether is arranged on both sides of the airbag (in the transverse direction, as seen from the associated vehicle seat).

Bracing is also possible between individual support struts.

When the airbag is braced via at least one tether extending outside the inflatable chambers, said tether can be made of a single-layer fabric. Therefore, the tether need not be inflatable. In this case, the tether can be manufactured separately and can be sewn to the airbag, which saves material and facilitates the procedures. It is also conceivable to completely omit those tethers. Alternatively, it would of course be possible to weave the tether in one piece together with the remaining airbag and to design it as an inflatable chamber, if necessary.

The total volume of the airbag can be about 30 I, for example.

The inflator and/or the folded airbag are accommodated, prior to activation, in a holder in the floor of the vehicle, for example, so that they are not noticed by the vehicle occupant in the vehicle interior. For example, a complete airbag module that contains the airbag and the inflator(s) may be accommodated in the floor. In order to conceal the airbag module prior to activation, it can be mounted on a rotatable plate, for example, which is arranged above the holder so that, prior to activation, the airbag module is counter-sunk in the floor and, in a situation of restraint, is swiveled upward before the filling gas flows into the airbag.

In another embodiment, an additional restraint chamber is present which, when the airbag is fully inflated, is arranged in parallel to the restraint chamber and directly adjacent to the restraint chamber between the restraint chamber and the floor of the vehicle. The additional restraint chamber is preferably located in the same plane as the restraint chamber and the vertical support struts which are adjacent to the side of the restraint chamber. The additional restraint chamber helps to cushion the vehicle occupant's legs safely and to prevent them from being overstretched.

In particular, at least one overflow opening through which filling gas flows from the restraint chamber into the additional restraint chamber is positioned between the restraint chamber and the additional restraint chamber. The additional restraint chamber is preferably filled exclusively by a fluid connection to the restraint chamber so that filling gas flows always through the restraint chamber into the additional restraint chamber. Thus, the additional restraint chamber generally does not deploy before the restraint chamber has at least started to fill up.

The internal volumes of the restraint chamber and the additional restraint chamber are separated from each other by a partition in which the at least one overflow opening is formed. The partition preferably extends over the entire length of the additional restraint chamber in the transverse direction of the vehicle. For example, plural overflow openings are arranged along the connecting line so that the additional restraint chamber can be filled quickly and evenly over its entire length.

Preferably, the additional restraint chamber is folded, particularly rolled, in a package separate from the restraint chamber, before it is filled, so that it deploys and is filled later than the restraint chamber. Preferably, the additional restraint chamber deploys only after the remaining airbag has deployed and has assumed its three-dimensional shape. This ensures that the additional restraint chamber does not prevent the support struts from deploying and being filled.

The additional restraint chamber is preferably woven in one piece with the remaining airbag.

In a possible variant, the at least one overflow opening is formed by a weave pattern in the partition which in areas has a lower yarn density so that higher gas permeability results at these positions so that the filling gas can flow from the restraint chamber into the additional restraint chamber. In a different variant, the at least one overflow opening is formed by a woven two-layer portion in the otherwise one-piece woven partition through which the filling gas can overflow from the restraint chamber into the additional restraint chamber.

In order to position the additional restraint chamber quickly and safely at the desired position, it can be fixed to the laterally adjacent vertical support struts via lateral fabric portions at least prior to complete filling. The fabric portions preferably are not inflatable. It should be made sure, however, that the fabric portions do not exert any significant forces upon the support struts so that the three-dimensional shape of the airbag is affected as little as possible by the additional restraint chamber.

For example, the fabric portions are woven-in single-layer portions which are also woven in one piece with the remaining airbag.

Preferably, the fabric portions have a structure, particularly a weakened zone, which widens when a lateral tensile force acts upon the fabric portions. When those forces occur, the structure yields particularly by the weakened zone opening. In this way, lateral tensile forces acting upon the vertical support struts can be prevented. A shortening of the additional restraint chamber along the transverse vehicle direction resulting from the filling thereof is compensated for by a length of the fabric portions increasing in this direction. Therefore, no significant additional tensile forces upon the vertical support struts are generated by the additional restraint chamber.

The structure comprises, for example, one or more slits or a perforation on the surface of the respective fabric portion. Advantageously, the structure can be produced simultaneously with the cutting of the airbag after weaving by laser cutting.

As an alternative, or in addition, to the fabric portions, there can be provided tethers which extend between the lateral edges of the additional restraint chamber and each of the adjacent vertical support struts, and which position and, if necessary, stabilize the additional restraint chamber. In this case, too, it must be made sure, however, that the tethers are selected as to their positions and length so that substantially lateral tensile forces are prevented from being transferred to the vertical support struts.

### BRIEF DESCRIPTION OF THE DRAWINGS

In the following, the invention will be described in detail on the basis of plural embodiments. The drawings show in:

FIG. 1 a schematic perspective view of an airbag of a vehicle occupant protection system according to the invention as set forth in a first embodiment;

FIG. 2 a schematic perspective view of an airbag of a vehicle occupant protection system according to the invention as set forth in a second embodiment;

FIG. 3 a schematic view of the vehicle occupant protection system of FIG. 2 in a situation of restraint;

FIG. 4 a Flatly Spread Cutting of the Airbag of FIG. 2;

FIG. 5 a schematic perspective view of an airbag of a vehicle occupant protection system according to the invention as set forth in a third embodiment;

FIG. 6 a flatly spread cutting of the airbag of FIG. 5;

FIG. 7 a schematic perspective view of an airbag of a vehicle occupant protection system according to the invention as set forth in a fourth embodiment, when inflated;

FIG. 8 the Airbag of FIG. 7 in a front view;

FIG. 9 a schematic lateral view of the airbag of FIG. 7 in a variant;

FIG. 10 a schematic detail view of the layers of the airbag of FIG. 7 in a corner area of the airbag;

FIGS. 11 and 12 schematic views of the attachment points of the central layers at the two outer layers of the airbag;

FIG. 13 a schematic perspective view of a vehicle occupant protection system according to the invention as set forth in a fifth embodiment;

FIG. 14 a schematic lateral view of the airbag of FIG. 13;

FIG. 15 a schematic view of the airbag of FIG. 13 prior to the filling of an additional restraint chamber;

FIG. 16 a schematic view of the airbag of FIG. 13 after the filling of the additional restraint chamber; and

FIGS. 17 and 18 schematic views of overflow openings from the restraint chamber to the additional restraint chamber of the airbag of FIG. 13.

### DESCRIPTION

Like, similar or equally acting components of all embodiments are marked with the same reference signs or with reference signs increased by 100. For reasons of clarity, all identical components are not always provided with reference signs.

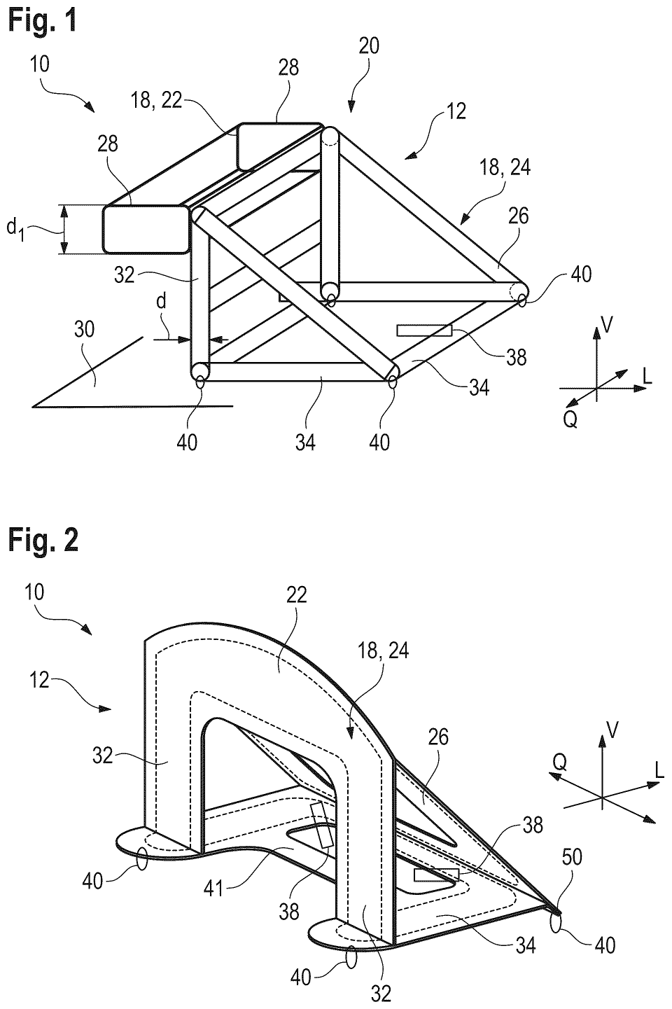

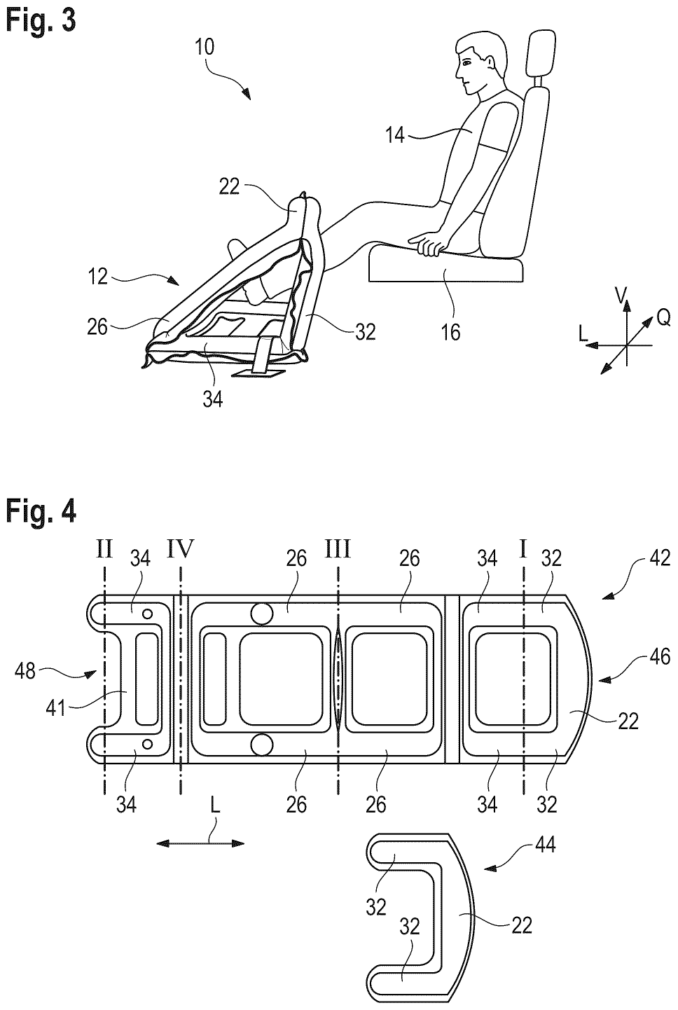

FIG. 1 illustrates a vehicle occupant protection system 10 comprising an airbag 12 that is designed for the protection of the legs of a vehicle occupant 14 in a vehicle seat 16 (see FIG. 3) as set forth in a first embodiment, when fully inflated.

The airbag 12 comprises several tubular chambers 18 which are in fluid connection with one another and which together form a type of three-dimensional wedge-shaped frame 20.

The clearances between the tubular chambers 18 are left open. In this embodiment, the airbag 12 is made only of the tubular chambers 18.

One of the tubular chambers 18 is designed as a restraint chamber 22 and in this example has a larger diameter d1 as compared to the diameter d of the remaining tubular chambers 18. The restraint chamber 22 in this case is arranged in the upper area of the airbag 12 at the uppermost (relating to a vertical direction V) and rearmost (relating to a longitudinal direction L facing away from the vehicle seat 16) tubular chamber 18 and extends along a transverse direction Q of the vehicle seat 16 normal to the longitudinal direction L and to the vertical direction V.

The airbag 12 is oriented so that the restraint chamber 22 is located on the side of the airbag 12 facing the vehicle seat 16.

The remaining tubular chambers 18 form support struts 24 that ensure the dimensional stability of the airbag 12. The frame 20 is designed so that the airbag 12, when inflated, is dimensionally stable in itself.

In this example, two diagonal support struts 26 are provided which are attached to the longitudinal ends 28 of the restraint chamber 22 and extend to a floor 30 of the vehicle.

Moreover, two vertical support struts 32 which equally extend to the floor 30 are attached to the longitudinal ends 28 of the restraint chamber 22. The opposite ends of the diagonal support struts 26 and the vertical support struts 32 are connected to each other by floor-level support struts 34. The floor-level support struts 34 in this case form a rectangle that rests on the floor 30. In addition, a further support strut 24 is arranged between the two vertical support struts 32 between the floor-level support struts 34 and the uppermost cross strut connected to the restraint chamber 22.

In this example, the restraint chamber 22 protrudes from the vertical support struts 32 to a certain extent along the longitudinal direction L.

The airbag 12 is in fluid connection with an inflator 38 that supplies filling gas to the airbag 12. The total filling volume of the airbag 12 may be about 30 I, for example.

When not activated, the airbag 12 and the inflator 38 are arranged on the floor 30 of the vehicle. For example, they are concealed in a holder (not shown) in the floor which accommodates an airbag module in which the inflator 38 and the folded airbag 12 are provided.

The airbag 12 is fixed on the floor 30, such as via holding fixtures 40 at the floor-level ends of the diagonal support struts 26 and the vertical support struts 32 which are connected to appropriate holding structures (not shown) on the floor 30.

FIG. 2 illustrates a second embodiment of the airbag 12. In contrast to the first embodiment, the restraint chamber 22 is aligned above the two vertical support struts 32 in the vertical direction V with the latter, while the central support strut 24 is omitted. Consequently, the two vertical support struts 32 and the restraint chamber 22 constitute a kind of gateway that is delimited on the rear by the two diagonal support struts 26.

Further, the two floor-level support struts 34 extending in the longitudinal direction Lare connected to each other by a non-inflatable tether 41.

In this embodiment, two inflators 38 are used which are arranged in the area of the floor-level support struts 34, particularly in the area of the longitudinal ends of the rearmost floor-level support strut 34.

FIG. 3 illustrates the orientation of the airbag 12 relative to the vehicle occupant 14 in a situation of restraint. The diagonal support struts 26 extend away from the vehicle seat 16 to the floor 30 and support the airbag 12 on the floor 30.

If a situation of restraint occurs, the inflator 38 is activated and the airbag 12 is inflated. In doing so, the airbag 12 deploys out of its holder on the floor 30 in curved shape toward the vehicle occupant 14 in the vehicle seat 16 so that the restraint chamber 22 moves from above over the legs of the vehicle occupant 14. As shown in FIG. 3, the restraint chamber 22 cushions the legs of the vehicle occupant 14, when they are swinging upwards.

The floor-level support struts 34 positioned beneath the restraint chamber 22 or the support strut 24 arranged there above are designed in the airbag according to FIG. 1, for example, to cushion the heels of the vehicle occupant 14 and to stop a forward movement of the vehicle occupant 14, if necessary, unless the legs move as indicated in FIG. 3.

As an alternative, the airbag 12 could be arranged in the area of a structure affixed to the vehicle and could be used, e.g., as a knee airbag.

FIG. 4 illustrates the cutting 42, 44 of the airbag 12 of FIG. 2. Except for the front side 44 of the vertical support struts 32 and the restraint chamber 22, the cutting 42 is made of one single piece of a suitable airbag fabric.

The cutting 42 is elongated and is folded several times along the later longitudinal direction L to form the airbag 12. The folded portions are partially sewn to one another along the longitudinal direction L, thereby forming the individual tubular chambers 18. Said seams are indicated by broken lines in FIG. 2. In this way, also overflow openings between the individual tubular chambers 18 are realized.

For example, the right-hand end 46 in FIG. 4 forming the restraint chamber 22 in the finished airbag is folded along the folding line I and is connected to the line II at the left-hand end 48. The remaining cutting is folded again along the folding lines III and IV, thereby forming the diagonal support struts 26, and is sewn up with the end 46 in the area of the folding line III.

The separate front side 44 is sewn up with the ends 48, 46 to complete the vertical support struts 32 and the restraint chamber 22.

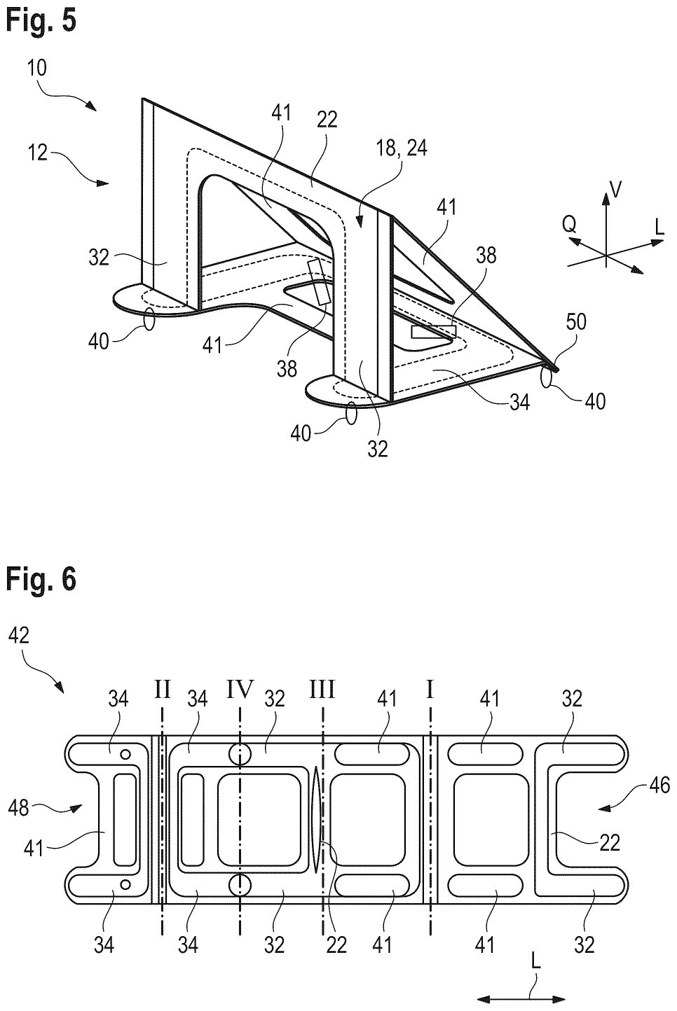

In the area of the folding lines III, IV, appropriate darts 50 which define the angles between the individual tubular chambers 18 and/or support struts 24 and impart the desired wedge shape to the inflated airbag 12 are produced by corresponding seams (see FIGS. 2 and 5).

The tether 41 is formed by a portion of the cutting 42 that is not covered with any other matching cutting portion.

FIGS. 5 and 6 illustrate a third embodiment of the airbag 12 and the cutting 42 thereof. The main difference from the second embodiment resides in the fact that the diagonal support struts are formed by non-inflatable tethers 41.

FIG. 6 illustrates the cutting 42 of the airbag 12 of FIG. 5 which consists of only one single piece of fabric. As in the previous embodiment, the portions of the cutting 42 are appropriately brought into the desired shape by folding about suitable folding lines I, II, III, IV normal to the longitudinal direction L and by sewing the individual cutting portions to each other, wherein also the tubular chambers 18 are formed. The tethers 41 are formed integrally with the cutting 42 and are already connected to the former at their two longitudinal ends so that no further sewing step is required. In this example, two cutting portions are superimposed in the area of the tethers 41, but they are not connected in such a way that inflatable chambers are formed.

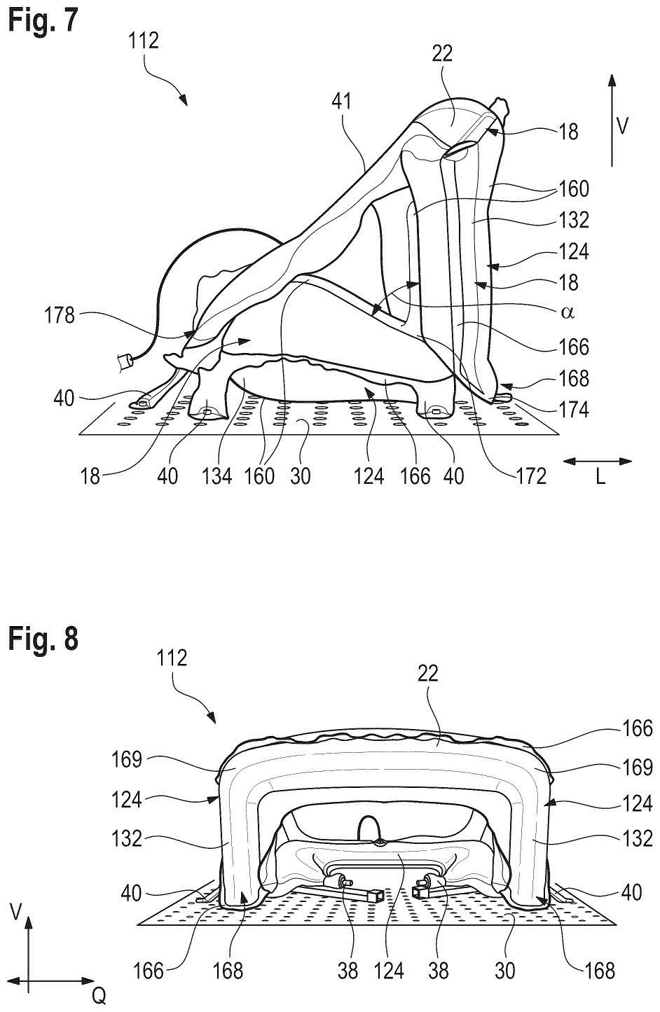

FIGS. 7 to 12 illustrate a fourth embodiment of the airbag 112. In this example, at least the portion of the airbag 112 that comprises the inflatable chambers 18 including the restraint chamber 22 and several support struts 124 is one-piece woven, i.e. manufactured in an OPW process.

In this example, at least several of the inflatable chambers 18 are designed in three or more layers. At least one central layer 162 extending freely through the interior 164 of the respective inflatable chambers 18 extends between two outer layers 160 which form a cover of the airbag 112 and seal off the latter against the environment (see FIG. 10).

All layers 160, 162 are formed simultaneously during the weaving process and constitute one single fabric layer at the edge areas 166 of the chambers 18 where the two outer layers 160 meet.

The central layer 162 is formed by warp and/or weft yarns which alternate between the two outer layers 160, alternatively or additionally also by pile yarns (not shown) which float in the two outer layers 160.

In the restraint chamber 22 one single central layer 162 extends freely through the interior 164 of said chamber and extends substantially through the entire restraint chamber 22 between the two outer layers 160 thereof.

In all examples, the central layer 162 can be formed by individual parallel yarns (warp, weft or pile yarns) or by a fabric made of warp, weft and/or pile yarns.

In the embodiment shown here, all inflatable chambers 18 including the restraint chamber 22 and the support struts 124 are designed in this way (see FIG. 10). Of course, it would also be conceivable, however, to provide central layers 162 in several chambers 18 only.

In the variant of the airbag 112 shown here, on one side of the airbag 112 a first support strut 124 extends as a floor-level support strut 134 in parallel to the floor 30 of the vehicle up to an inflatable corner area 168. On the opposite side of the corner area 168, another support strut 124 is adjacent which forms a vertical support strut 132 and extends approximately perpendicularly from the floor 30 to the top. The restraint chamber 22 which extends approximately perpendicularly to the plane spanned by the two support struts 134, 132 (in FIG. 7 into the image plane) is arranged at the upper free end of said support strut 132.

An identical arrangement of two support struts 132, 134 with an interposed corner area 168 is provided, relating to the transverse direction Q of the airbag 112, on the opposite side of the airbag 112. The vertical support struts 132 end in opposite ends 169 of the restraint chamber 22 and are directly converted into the restraint chamber 22 here (see FIG. 8).

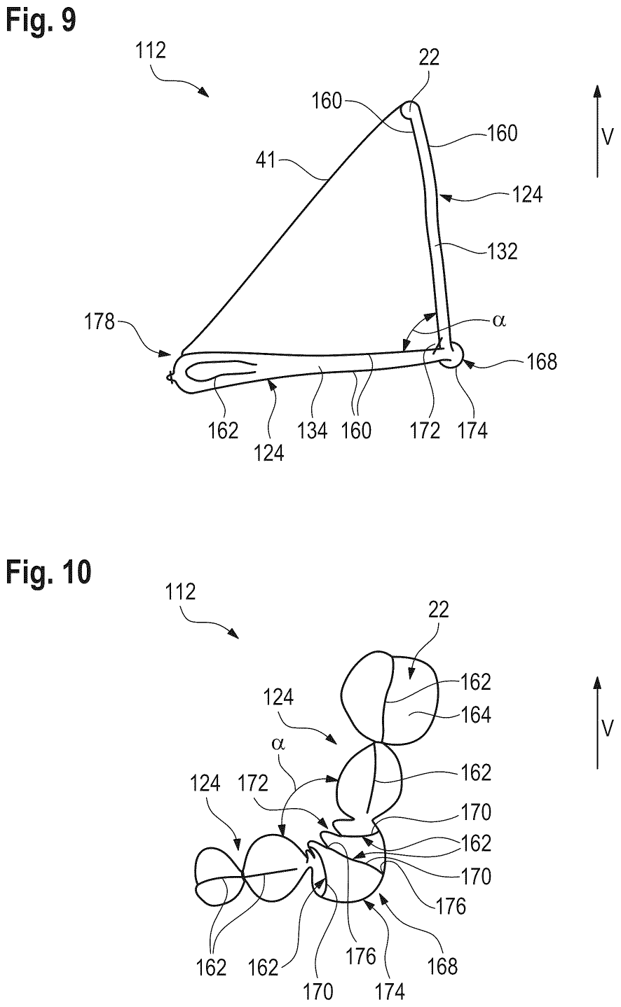

In the corner area 168, the two support struts 132, 134 of one side of the airbag 112 enclose an angle a between them that is about 90°in this case (see e.g. FIGS. 7 and 9). Consequently, the airbag 112 describes a curvature about the angle a in the corner area 168.

This curvature of the corner area 168 is achieved particularly by one or more central layers 162 which extend through the interior of the corner area 168 and connect the two outer layers 160 to each other in the corner area 168.

As shown in FIG. 10, in the corner area 168 along the direction from the floor-level support strut 134 to the vertical support strut 132, several, namely three, central layers 162 are successively provided, each extending from one of the outer layers 160 to the opposite outer layer 160. Said central layers 162 form inner tethers 170 which connect the outer layer 160 on an inner side of the curvature 172 of the corner area 168 to the opposed outer layer 160 on an outer side of the curvature 174 of the corner area 168. The position and the length of said inner tethers 170 enforce the desired curvature of the corner area 168 when the airbag 112 is inflated.

In the inner tethers 170, each of the yarns from one of the outer layers 160 extends from an attachment point 176 in the outer layer 160 through the interior 164 of the inflatable chamber 18 to an attachment point 176 on the opposite outer layer 160 and there enter into the fabric bond thereof. At the next attachment point 176 of said outer layer 160, yarns leave the fabric bond of said outer layer 160 and as the next inner tether 170 extend through the interior of the corner area 168, until they enter into the fabric bond of the opposite outer layer 160 again at a further attachment point 176.

In this way, several inner tethers 170 extend from successive attachment points 176 between the two outer layers 160 forming the inner side of the curvature 172 and the outer side of the curvature 174. Accordingly, the number of yarns and the yarn density of the outer layers 160 varies in each case. The inner tethers 170 are only formed when they leave an attachment point 176 and end at the associated attachment point 176 on the opposite outer layer 160.

The total number of the attachment points 176 defines the total number of the inner tethers 170. Therefore, the number of the attachment points 176 is equal at the two outer layers 160.

On the inner side of the curvature 172, the attachment points 176 of the inner tethers 170 are more closely adjacent each other than on the outer side of the curvature 174. The inner side of the curvature 172 is gathered by this arrangement, which effectively causes a shortening of the inner side of the curvature 172 in the corner area 168 so that a curvature is resulting between the two support struts 132, 134 about the angle a.

The inner tethers 170 in this example have a flat design and can extend e.g. over the entire depth of the corner area 168 (in FIGS. 9 and 10 perpendicular to the image plane).

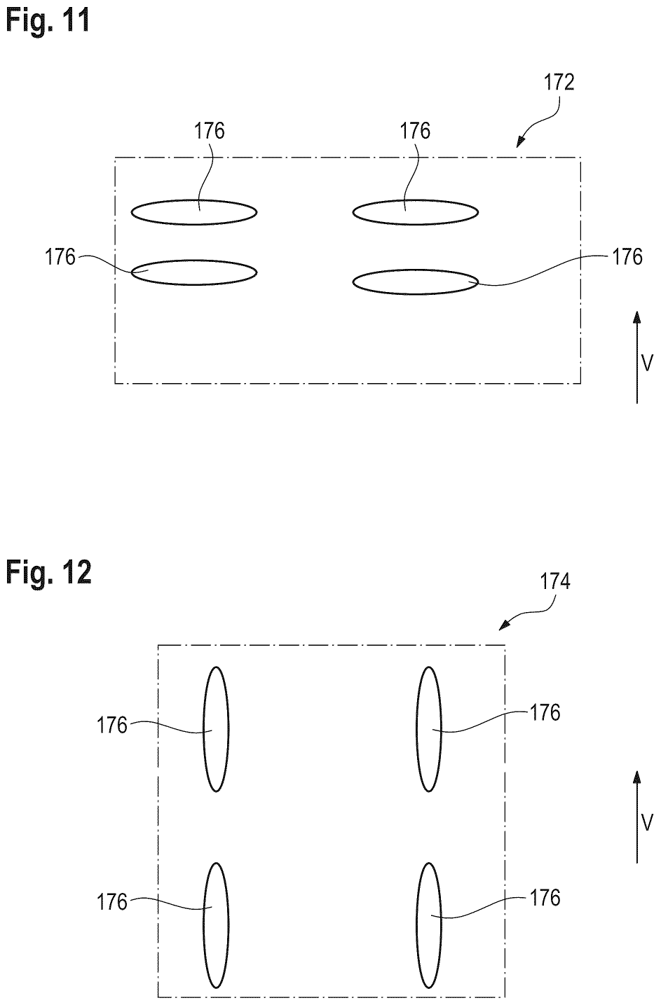

Accordingly, the attachment points 176 are elongated (see FIGS. 10 and 11).

FIGS. 11 and 12 illustrate that the attachment points 176 on the inner side of the curvature 172 are arranged transversely in relation to the vertical direction V (FIG. 11), while the attachment points 176 on the outer side of the curvature 174 are positioned along the vertical direction V (FIG. 12). Thus, the inner tethers 170 perform a rotation about an angle, about 90° in this case, between the inner side of the curvature 172 and the outer side of the curvature 174. This also promotes the desired curvature of the corner area 168 and increases the stability of the airbag 112. Different arrangements are also conceivable, of course.

In the shown example, the airbag 112 includes, analogously to the preceding embodiments, two tethers 41 that connect the restraint chambers 22 at each of their ends 169 to an end area 178 of the floor-side support struts 134 opposed to the corner area 168. In a variant, the tethers 41 are formed of a normal single-layer airbag fabric. In such case, they are cut separately and sewn up with the airbag 112. As an alternative, they could also be woven in one piece with the remaining airbag 112 and optionally could be designed as inflatable chambers.

The holding fixtures 40 that connect the inflator 38 to the floor 30 in this example are also woven in one piece with the airbag 112 and constitute a part of the edge area 166.

As in the afore-described embodiments, there are provided one or more inflators 38 which supply filling gas to the airbag 112. The above-described protective layers at the point where an inflator 38 protrudes into the interior of an inflatable chamber 18 of the airbag 112 are also realized here by one or more central layer(s) 162 woven in one piece with the remaining airbag 112.

Basically, it is possible to arrange one or more central layers 162 between the two outer layers 160 in an inflatable chamber 18 which is, e.g., a support strut 124, a corner area 168 or a restraint chamber 22, wherein particularly several inner layers 162 can follow one another along the longitudinal extension of the respective inflatable chamber 18.

The features of the individual embodiments can be freely combined or exchanged for one another at the skilled person's discretion.

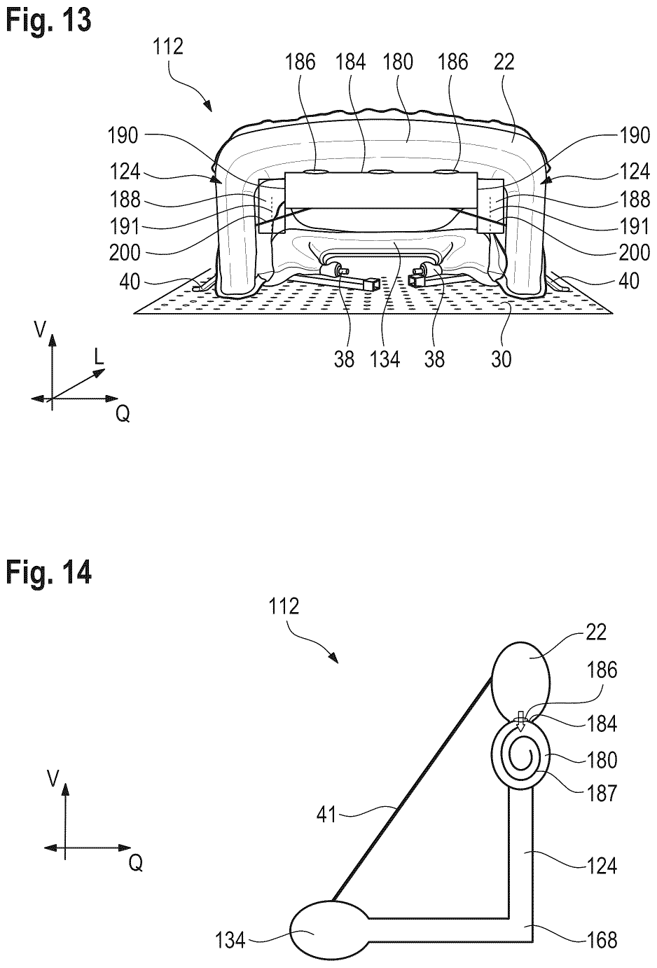

In the fifth embodiment of a vehicle occupant protection system 10 illustrated in FIGS. 13 to 18, the airbag 112 includes an additional restraint chamber 180 in addition to the restraint chamber 22.

The additional restraint chamber 180 extends, when the airbag 112 is completely inflated, in parallel to the restraint chamber 22 and directly adjacent to the latter beneath the restraint chamber 22, viz. between the restraint chamber 22 and the floor 30. Concerning the vertical direction V and the longitudinal direction L, the additional restraint chamber 180 is located in the same plane as the restraint chamber 22 and the vertical support struts 124.

The additional restraint chamber 180 acts, just as the restraint chamber 22, from above upon the feet and the shins of the vehicle occupant 14 and cushions the legs of the vehicle occupant 14 during a collision of the vehicle. The function of the airbag 112 therefore is identical to that shown in the above-described embodiments.

The additional restraint chamber 180 is approximately as long as the restraint chamber 22 in relation to the transverse vehicle direction Q and, when fully inflated, has a similar height in relation to the vertical direction V.

Along the transverse vehicle direction Q, the additional restraint chamber 180 is connected tightly and permanently over its entire inflatable area via a partition 184.

In the partition 184, several overflow openings 186 are formed through which filling gas overflows from the restraint chamber 22 into the additional restraint chamber 180, when the restraint chamber 22 is filled. The overflow openings 186 are the only fluid connection of the additional restraint chamber 180 to the remaining airbag 112 so that filling gas flows into the additional restraint chamber 180 only via the restraint chamber 22.

In this example, the additional restraint chamber 180 is woven in one piece together with the remaining one-piece manufactured portions of the airbag 112.

FIG. 17 shows a variant in which the overflow openings 186 are realized by a weave pattern in the partition 184 that in some areas has a smaller number of yarns so that the fabric has a higher gas permeability at those positions.

FIG. 18 shows a variant in which the overflow openings 186 are formed by the fact that two-layer portions which form insides of the overflow openings 186 and between which the filling gas can overflow from the restraint chamber 22 into the additional restraint chamber 180 are woven into the otherwise one-piece woven partition 184.

Before filling, the additional restraint chamber 180 in this example is rolled along the vertical direction V into a package 187 separate from the restraint chamber 22 and, in said rolled state, is fixed by a holding device provided with a weakened zone (not shown). The holding device is released only when sufficient filling gas starts to flow from the restraint chamber 22 through the overflow openings 186 into the still rolled additional restraint chamber 180.

In this example, the additional restraint chamber 180 is connected to the vertical support struts 124 laterally via two fabric portions 188 at each lateral edge 190 of the additional restraint chamber 180.

The two fabric portions 188 are single-layer areas one-piece woven with the remaining airbag 112 and are not inflatable in this case.

In order to prevent the three-dimensional shape of the airbag 112 from being deformed by the additional restraint chamber 180, lateral tensile forces F acting on the fabric portions 188 which occur during shortening while the additional restraint chamber 180 is filled, are taken up by a structure 191 in each of the fabric portions 188.

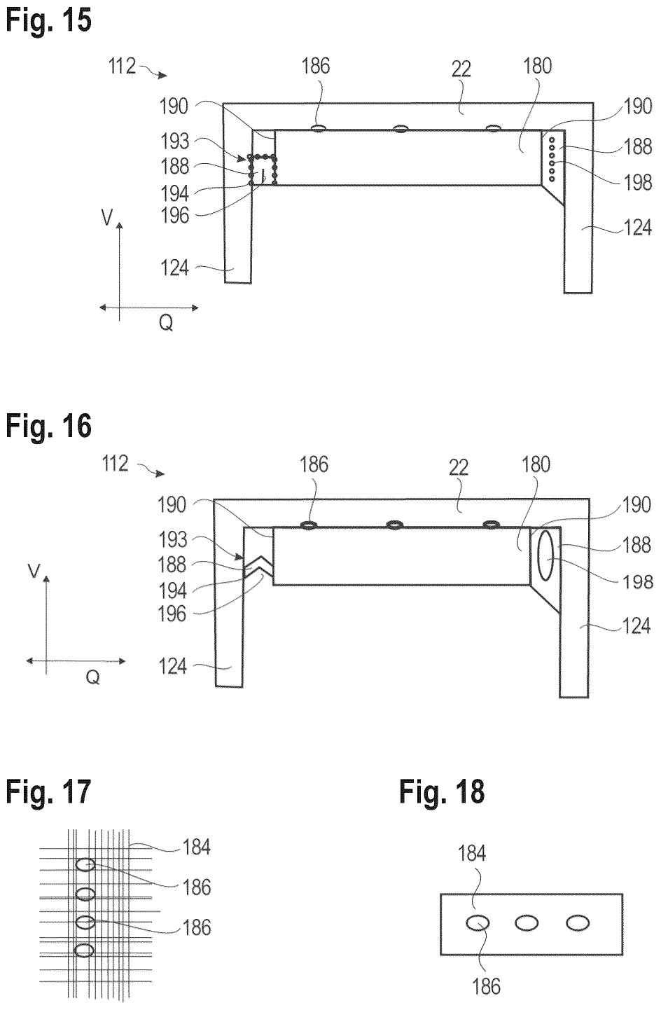

Examples of this are shown in FIGS. 15 and 16. The left side of each of the FIGS. 15 and 16 represents a first variant, whereas the right side of each of the FIGS. 15 and 16 shows a second variant.

In the first variant, the structure 191 is realized by weakened zones 192 in an upper end area 193 relative to the vertical direction V which are introduced both between the fabric portion 188 and the adjacent vertical support strut 124 and between the fabric portion 188 and the adjacent lateral edge 190 of the additional restraint chamber 180. Moreover, another weakened zone 196 is positioned at a lower end 194 on the surface of the fabric portion 188.

While the support struts 124 are filled, the weakened zones 192, 196 remain still intact (FIG. 15). While the additional restraint chamber 180 starts to fill up, however, and tensile forces F are created which act upon the fabric portions 188 along the transverse vehicle direction Q laterally in the direction of the additional restraint chamber 180, the weakened zones 192, 196 are loaded and tear. In doing so, the fabric portions 188 stretch along the transverse vehicle direction Q, as can be seen from FIG. 16, and compensate for the difference in length that results from the shortening of the additional restraint chamber 180 along the transverse vehicle direction Q, when the latter is filled. Therefore, no significant forces act upon the vertical support struts 124 so that the airbag 112 substantially assumes the same three-dimensional shape when it is completely inflated as without the additional restraint chamber 180.

In the second variant, one single weakened zone 198 is arranged on the surface of the fabric portion 188 (FIG. 15). When, as described for the first variant, tensile forces F occur along the transverse vehicle direction Q toward the additional restraint chamber 180, the weakened zone 198 opens so that a continuous opening is formed which allows the fabric portion 188 to expand laterally and, thus, compensate for the tensile forces F (FIG. 16).

The structures 191, i.e. the weakened zones 192, 196, 198 in this case, are produced by laser cutting in this example in the same working step as the cutting of the airbag 112 after weaving which is also carried out by means of laser cutting here.

As is shown in FIG. 13 illustrates, additional, in this case diagonal, tethers 200 can be provided from the additional restraint chamber 180 to each of the adjacent vertical support struts 124 in order to stabilize the position of the additional restraint chamber 180 in the fully inflated airbag 112. The tethers 200 are designed in such a way that no significant tensile forces are transferred into the vertical support struts 124.

1. A vehicle occupant protection system comprising an airbag for the protection of the legs of a vehicle occupant, wherein, prior to activation of the vehicle occupant protection system, the airbag is arranged folded on a floor of a vehicle in front of an associated vehicle seat and deploys in a situation of restraint from the floor in front of the vehicle seat, wherein the airbag comprises several tubular inflatable chambers being in fluid connection which, when inflated, are connected three-dimensionally to one another, wherein several of the chambers form support struts of the airbag while at least one of the chambers in an upper area of the airbag forms a restraint chamber, wherein, when the airbag is completely inflated, the restraint chamber is arranged directly in front of a shin area, a knee area or a pelvis area of the vehicle occupant and wherein at least the portions of the airbag which include the inflatable chambers are one-piece woven.

2. The vehicle occupant protection system according to claim 1, wherein at least portions of the airbag have at least three superimposed layers in the inflatable chambers wherein a central layer is located between two outer layers which seal off the airbag against the environment.

3. The vehicle occupant protection system according to claim 2, wherein the central layer has a woven structure.

4. The vehicle occupant protection system according to claim 2, or wherein the central layer extends in a corner area of the airbag at least at one attachment point from one of the outer layers to the opposite outer layer through the interior of the airbag so that two support struts between which the corner area is located abut on each other, when inflated, at an angle (α) other than 0°.

5. The vehicle occupant protection system according to claim 4, wherein an inner side of the curvature of the corner area is gathered by the central layer(s).

6. The vehicle occupant protection system according to claim 5, wherein several attachment points for the central layer are provided on each of the inner side of the curvature and on an opposite outer side of the curvature of the airbag in the corner area and the attachment points on the outer side of the curvature are spaced further apart from each other than on the inner side of the curvature.

7. The vehicle occupant protection system according to claim 4, wherein the central layer in the corner area has a flat design and extends rotated between the attachment points on the inner side of the curvature and the outer side of the curvature about an angle other than 0°, particularly about 90°.

8. The vehicle occupant protection system according to claim 2, wherein the central layer constitutes a protective layer for the outer layers in a connecting area of an inflator.

9. The vehicle occupant protection system according to claim 2, in the inflatable chambers outside a corner area, the central layer extends along the longitudinal extension of the chambers through the respective chamber.

10. The vehicle occupant protection system according to claim 2, wherein all layers are woven in one piece with one another.

11. The vehicle occupant protection system according to claim 1, wherein the airbag is braced via at least one tether extending outside the inflatable chambers and the tether is made of a single-layer fabric.

12. The vehicle occupant protection system according to claim 1, wherein an additional restraint chamber is provided which, when the airbag is completely inflated, is arranged in parallel to the restraint chamber and directly adjacent to the restraint chamber between the restraint chamber and the floor of the vehicle.

13. The vehicle occupant protection system according to claim 12, wherein at least one overflow opening through which filling gas flows from the restraint chamber into the additional restraint chamber is arranged between the restraint chamber and the additional restraint chamber.

14. The vehicle occupant protection system according to claim 12, wherein the additional restraint chamber is fixed to the vertical support struts via lateral fabric portions at least before the complete filling.

15. The vehicle occupant protection system according to claim 14, wherein the fabric portions include a structure particularly a weakened zone which widens when a lateral tensile force (F) acts upon the fabric portions.
